(19) United States
(12) Patent Application Publication
(10) Pub. No.: US 2025/0260241 A1
(43) Pub. Date: Aug. 14, 2025

(54) TECHNIQUES FOR PERFORMING SOFT START FOR ONE OR MORE BATTERIES

(71) Applicant: QUALCOMM Incorporated, San Diego, CA (US)

(72) Inventors: Xinying DING, Cupertino, CA (US); Guoyong GUO, San Jose, CA (US); Qian YAO, Cupertino, CA (US); Neal HOROVITZ, Los Altos, CA (US)

(21) Appl. No.: 18/904,360

(22) Filed: Oct. 2, 2024

Related U.S. Application Data
(60) Provisional application No. 63/552,515, filed on Feb. 12, 2024.

(51) Int. Cl. H02J 7/00

(52) U.S. Cl. CPC H02J 7/0019; H02J 7/0024; H02J 7/0045; H02J 7/007182; H02J 7/007192

(57) ABSTRACT

Certain aspects of the present disclosure are directed towards techniques and apparatus for battery soft start. An example method generally includes: detecting connection of a first battery, wherein a first transistor is coupled between the first battery and an output node of a power supply circuit for the electronic device, and wherein an output capacitive element coupled to the output node; biasing the first transistor in a soft start operating mode to charge the output capacitive element based on the detection; detecting connection of a second battery, wherein a second transistor is coupled between the second battery and the output node; comparing a first battery voltage (VBAT) of the first battery and a second VBAT of the second battery; and biasing the first transistor in a second operating mode based on the comparison and an output voltage at the output node.

### CROSS-REFERENCE TO RELATED APPLICATION

The present application for patent claims the benefit of priority to U.S. Provisional Patent Appl. No. 63/552,515, filed Feb. 12, 2024, which is hereby incorporated by reference herein in its entirety.

### TECHNICAL FIELD

Certain aspects of the present disclosure generally relate to power supply circuits and, more particularly, to techniques and apparatus for battery soft start.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator (also known as a “switching converter” or “switcher”) may be implemented, for example, by a switched-mode power supply (SMPS), such as a buck converter, a boost converter, a buck-boost converter, or a charge pump.

For example, a buck converter is a type of SMPS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

A charge pump is a type of SMPS typically comprising at least one switching device to control the connection of a supply voltage across a load through a capacitor. In a voltage doubler (also referred to as a “multiply-by-two (X2) charge pump”), for example, the capacitor of the charge pump circuit may initially be connected across the supply, charging the capacitor to the supply voltage. The charge pump circuit may then be reconfigured to connect the capacitor in series with the supply and the load, doubling the voltage across the load. This two-stage cycle is repeated at the switching frequency for the charge pump. Charge pumps may be used to multiply or divide voltages by integer or fractional amounts, depending on the circuit topology.

Power management integrated circuits (power management ICs or PMICs) are used for managing the power scheme of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure are directed towards a method for battery soft start. The method generally includes: detecting connection of a first battery to an electronic device, wherein a first transistor is coupled between the first battery and an output node of a power supply circuit for the electronic device, and wherein an output capacitive element coupled to the output node; biasing the first transistor in a soft start operating mode to charge the output capacitive element based on the detection; detecting connection of a second battery to the electronic device, wherein a second transistor is coupled between the second battery and the output node; comparing a first battery voltage (VBAT) of the first battery and a second VBAT of the second battery in response to detecting the connection of the second battery; and biasing the first transistor in a second operating mode based on the comparison and an output voltage at the output node.

Certain aspects of the present disclosure are directed towards an electronic device. The electronic device generally includes: a power supply circuit including a first transistor coupled between a terminal for a first battery and an output node of the power supply circuit and a second transistor coupled between a terminal for a second battery and the output node, wherein an output capacitive element is coupled to the output node; a controller coupled to the power supply circuit and configured to: detect connection of the first battery to the electronic device; bias the first transistor in a soft start operating mode to charge the output capacitive element based on the detection; detect connection of the second battery to the electronic device; compare a first VBAT of the first battery and a second VBAT of the second battery in response to detecting the connection of the second battery; and bias the first transistor in a second operating mode based on the comparison and an output voltage at the output node.

Certain aspects of the present disclosure are directed towards an electronic device. The electronic device generally includes: a power supply circuit including a first transistor coupled between a terminal for a first battery and an output node of the power supply circuit and a second transistor coupled between a terminal for a second battery and the output node, wherein an output capacitive element is coupled to the output node; a controller coupled to the power supply circuit and configured to: detect connection of the first battery to the electronic device; bias the first transistor in a soft start operating mode to charge the output capacitive element based on the detection; fully turn on the first transistor based on an output voltage at the output node being with a threshold voltage of a first VBAT of the first battery; detect connection of the second battery to the electronic device; determine whether the first VBAT and a second VBAT of the second battery are balanced in response to detecting the connection of the second battery; and bias the second transistor based on the determination.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management system that includes a power management integrated circuit (PMIC) and a battery charging circuit, in which aspects of the present disclosure may be practiced.

FIG. 2 is a circuit diagram of an example power supply circuit, in accordance with certain aspects of the present disclosure.

FIG. 3 is a circuit diagram of an example power supply circuit including a switched-mode power supply (SMPS) circuit and multiple independently controlled charging paths, in accordance with certain aspects of the present disclosure.

FIG. 4 illustrates example operations for soft starting batteries, in accordance with certain aspects of the present disclosure.

FIG. 5 illustrates graphs showing battery voltages and changes in an output voltage of a power supply circuit in response to batteries being plugged in, in accordance with certain aspects of the present disclosure.

FIG. 6 illustrates graphs showing input voltage, battery voltages, and an output voltage in response to providing the input voltage and plugging in batteries, in accordance with certain aspects of the present disclosure.

FIG. 7 is a flow diagram of example operations for battery soft start, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for controlling soft start when one or more batteries are plugged into an electronic device. The electronic device may be implemented with at least one battery selectively coupled to an output voltage node of a power supply circuit of the electronic device. A capacitive element may be coupled to the output voltage node. When a first battery is plugged into the electronic device, an associated transistor for the first battery may be biased in a soft start operating mode (e.g., a linear region of operation) to charge the output capacitive element until the output voltage at the output voltage node reaches the voltage of the battery before fully turning on the transistor. In some aspects, multiple batteries may be plugged into the electronic device (e.g., at different times). The voltages of the batteries may be compared to determine how to bias the associated transistors for the batteries. For example, if a second battery is plugged in with a higher voltage than the first battery, the transistor for the first battery may be turned off when the output voltage reaches the voltage of the first battery to facilitate the soft start of the second battery or batteries. For instance, the first battery's voltage may be compared with the voltages of any other batteries (e.g., second battery) attached to the device to decide the bias condition of the associated transistor (QBAT). In some cases, the soft start may be performed for one or more batteries that are plugged in while the electronic device is plugged into an external voltage supply, as described in more detail herein.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

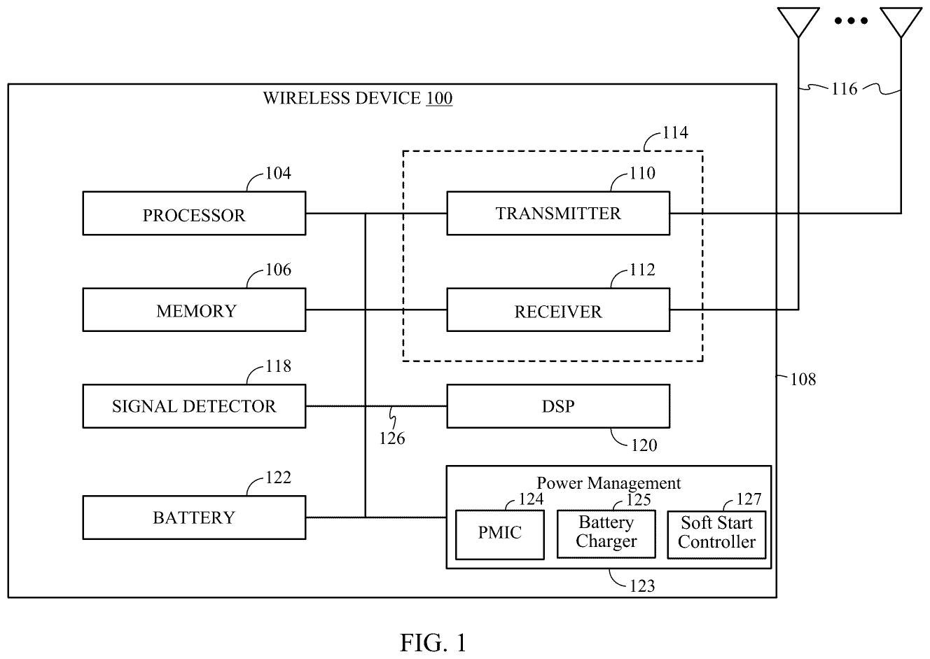

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, etc. For certain aspects, the device 100 may be a foldable device (e.g., a flip phone).

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when another power source—such as a wall adapter or a wireless power charger—is unavailable). The battery 122 may comprise a single cell or multiple cells connected in series and/or in parallel. The device 100 may further include additional independent batteries (not shown). Each of the additional independent batteries may comprise a single cell or multiple cells connected in series and/or in parallel.

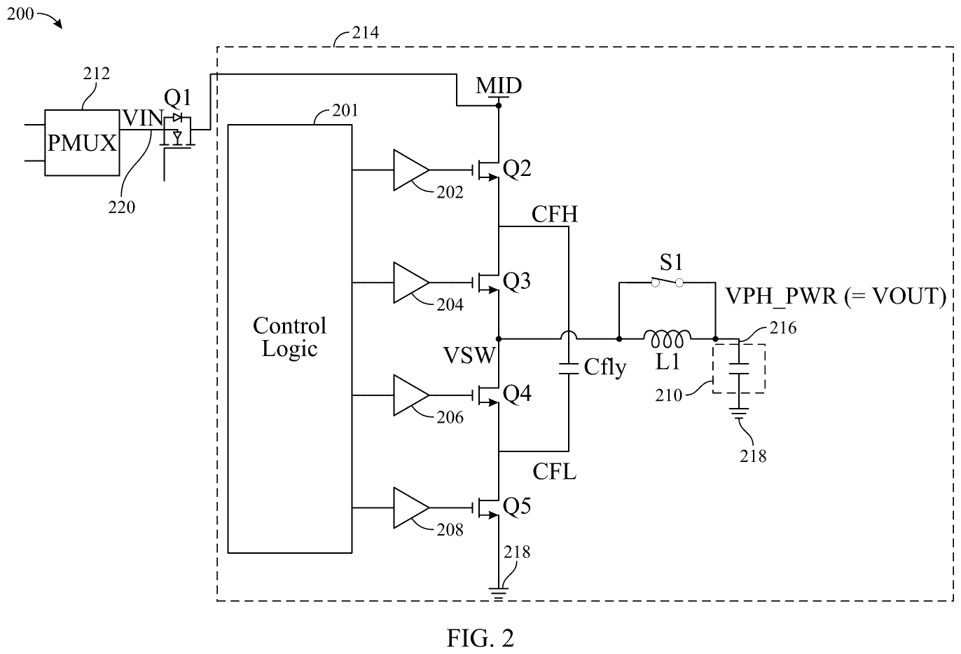

The device 100 may also include a power management system 123 for managing the power from the battery 122 (or batteries), a wall adapter, and/or a wireless power charger to the various components of the device 100. The power management system 123 may perform a variety of functions for the device such as DC-to-DC conversion, battery charging, power-source selection, voltage scaling, power sequencing, source mode power, etc. In certain aspects, the power management system 123 may include a power management integrated circuit (power management IC or PMIC) 124 and one or more power supply circuits, such as a battery charger 125, which may be controlled by the PMIC or logic associated with the battery charger, for example. For certain aspects, at least a portion of one or more of the power supply circuits (e.g., at least a portion of the battery charger 125) may be integrated in the PMIC 124. The PMIC 124 and/or the one or more power supply circuits may include at least a portion of a switched-mode power supply (SMPS) circuit, which may be implemented by any of various suitable switched-mode power supply circuit topologies, such as a two-level buck converter, a three-level buck converter, a charge pump, or an adaptive combination power supply circuit (e.g., the SMPS circuit 214 of FIG. 2), which can switch between operating in a buck converter mode and a charge pump mode, as described below.

In some aspects, the power management system 123 may also include a soft start controller 127. The soft start controller 127 may control soft start operations when one or more batteries are inserted for (and also removed from) the device 100, as described in more detail herein.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Circuits and Operation

As described above, the PMIC 124 and/or the one or more power supply circuits (e.g., battery charger 125) may include at least a portion of an SMPS circuit (e.g., a buck converter, a charge pump converter, or an adaptive combination power supply circuit capable of switching therebetween), which may be a single-phase or multi-phase converter. In the case of an adaptive combination power supply circuit, both converter modes may be single-phase, both converter modes may be multi-phase, one converter mode may be single-phase while the other converter mode is multi-phase or capable of changing between single-phase and multi-phase, or one converter mode may be multi-phase while the other converter mode is capable of changing between single-phase and multi-phase.

FIG. 2 is a circuit diagram of an example power supply circuit 200, which may be used to charge one or more batteries. As illustrated, the power supply circuit 200 includes a power multiplexer 212 (labeled “PMUX”), a reverse-current-blocking transistor Q1 (which may also be referred to as an overvoltage protection (OVP) field-effect transistor (FET) or an input FET), and an SMPS circuit 214 (e.g., an adaptive SMPS circuit).

The power multiplexer 212 may be configured to select between receiving power from, for example, (i) a Universal Serial Bus (USB) port for connecting to a wall adapter and (ii) a wireless power port (both not shown). The power multiplexer 212 may be implemented as a single-pole, double-throw (SPDT) switch by two OVP FETs, and in this case, transistor Q1 may be eliminated.

In certain aspects, the output of the power multiplexer 212 may be coupled to an input voltage node 220 (labeled “VIN”). The input voltage node 220 may be coupled to a source of the transistor Q1, and a drain of the transistor Q1 may be coupled to a voltage node (labeled “MID”) of the SMPS circuit 214. The MID voltage node may serve as the power supply rail of the SMPS circuit 214, and in some cases, may alternatively be considered as an input node of the SMPS circuit. In some cases, the power multiplexer 212 and/or transistor Q1 may be removed.

For certain aspects, the SMPS circuit 214 may have a two-level buck converter topology. For other aspects, the SMPS circuit 214 may have a single-phase three-level buck converter topology (as illustrated in the power supply circuit 200 of FIG. 2), and may include a second transistor Q2, a third transistor Q3, a fourth transistor Q4, a fifth transistor Q5, a flying capacitive element Cfly, an inductive element L1, and a capacitive element 210. For other aspects, the SMPS circuit 214 may have a dual-phase three-level buck converter topology. To realize an adaptive SMPS circuit, a switch S1 may be added across the inductive element L1 of the three-level buck converter topology. With the switch S1 closed, the adaptive SMPS circuit may function as a single-phase divide-by-two (Div2) charge pump converter, as further described below. In certain aspects, switch S1 may be implemented by two back-to-back transistors.

Transistor Q3 may be coupled to transistor Q2 via a first node (labeled “CFH” for flying capacitor high node), transistor Q4 may be coupled to transistor Q3 via a second node (labeled “VSW” for voltage switching node), and transistor Q5 may be coupled to transistor Q4 via a third node (labeled “CFL” for flying capacitor low node). For certain aspects, the transistors Q2-Q5 may be implemented as n-type metal-oxide-semiconductor (NMOS) transistors, as illustrated in FIG. 2. In this case, the drain of transistor Q3 may be coupled to the source of transistor Q2, the drain of transistor Q4 may be coupled to the source of transistor Q3, and the drain of transistor Q5 may be coupled to the source of transistor Q4. The source of transistor Q5 may be coupled to a reference potential node 218 (e.g., electric ground) for the power supply circuit 200. The flying capacitive element Cfly may have a first terminal coupled to the first node and a second terminal coupled to the third node. The inductive element L1 may have a first terminal coupled to the second node and a second terminal coupled to an output voltage node 216 (labeled “VOUT,” which may also be referred to as “VPH_PWR” or “VPH”) and the capacitive element 210.

Control logic 201 may control operation of the SMPS circuit 214 and other aspects of the power supply circuit 200. For example, the control logic 201 may control operation of the transistors Q2-Q5 via output signals to the inputs of respective gate drivers 202, 204, 206, and 208. The outputs of the gate drivers 202, 204, 206, and 208 are coupled to respective gates of transistors Q2-Q5. During operation of the adaptive SMPS circuit (or of a three-level buck converter), the control logic 201 may cycle through four different phases, which may differ depending on whether the duty cycle is less than 50% or greater than 50%.

Operation of the adaptive SMPS circuit with a duty cycle of less than 50% is described first. In a first phase (referred to as a “charging phase”), transistors Q2 and Q4 are activated, and transistors Q3 and Q5 are deactivated, to charge the flying capacitive element Cfly and to energize the inductive element L1. In a second phase (called a “holding phase”), transistor Q2 is deactivated, and transistor Q5 is activated, such that the VSW node is coupled to the reference potential node, the flying capacitive element Cfly is disconnected (e.g., one of the Cfly terminals is floating), and the inductive element L1 is deenergized. In a third phase (referred to as a “discharging phase”), transistors Q3 and Q5 are activated, and transistor Q4 is deactivated, to discharge the flying capacitive element Cfly and to energize the inductive element L1. In a fourth phase (also referred to as a “holding phase”), transistor Q4 is activated, and transistor Q3 is deactivated, such that the flying capacitive element Cfly is disconnected and the inductive element L1 is deenergized.

Operation of the adaptive SMPS circuit with a duty cycle greater than 50% is similar in the first and third phases, with the same transistor configurations. However, in the second phase (called a “holding phase”) following the first phase, transistor Q4 is deactivated, and transistor Q3 is activated, such that the VSW node is coupled to the MID node, the flying capacitive element Cfly is disconnected, and the inductive element L1 is energized. Similarly in the fourth phase (also referred to as a “holding phase”) with a duty cycle greater than 50%, transistor Q2 is activated, and transistor Q5 is deactivated, such that the flying capacitive element Cfly is disconnected and the inductive element L1 is energized.

Furthermore, the control logic 201 may have a control signal (not shown in FIG. 2) configured to control operation of switch S1 and selectively enable divide-by-two (Div2) charge pump operation. For certain aspects, when this control signal is logic low, switch S1 is open, and the power supply circuit 200 operates as a three-level buck converter using the inductive element L1. When this control signal is logic high for certain aspects, switch S1 is closed, thereby shorting across the inductive element L1 and effectively removing the inductive element L1 from the circuit, such that the adaptive SMPS circuit operates as a Div2 charge pump. The control logic 201 may be configured to automatically control operation of switch S1 (e.g., through the logic level of the control signal) based on an output current (also referred to as a “load current”) and/or an input current for the adaptive SMPS circuit.

### Example Power Supply Circuit with Multi-Batteries

Many portable devices may use multiple independent batteries. In some cases, such as foldable and flip phones and Internet of things (IoT) devices, the multiple independent batteries include batteries of varying capacities (e.g., asymmetrical batteries) that often result in challenges for charging, monitoring, and balancing the batteries. At least some multi-battery charging implementations are complex and expensive (e.g., in terms of cost and area) and may result in performance issues. For example, some multi-battery charging implementations may use multiple separate charging circuits and employ impedance-balancing circuitry (e.g., a current limit switch) to balance the batteries (e.g., prevent one battery from charging or discharging faster than another).

Certain aspects of the present disclosure provide techniques and apparatus for supporting the charging of multiple independent batteries using a power supply circuit that includes a switched-mode power supply (SMPS). Such a power supply circuit may control and monitor the charging of multiple independent batteries without using multiple chargers. For example, the power supply circuit may include independently controlled charging paths for each battery, each charging path having a switch (e.g., battery FET) to provide charging control.

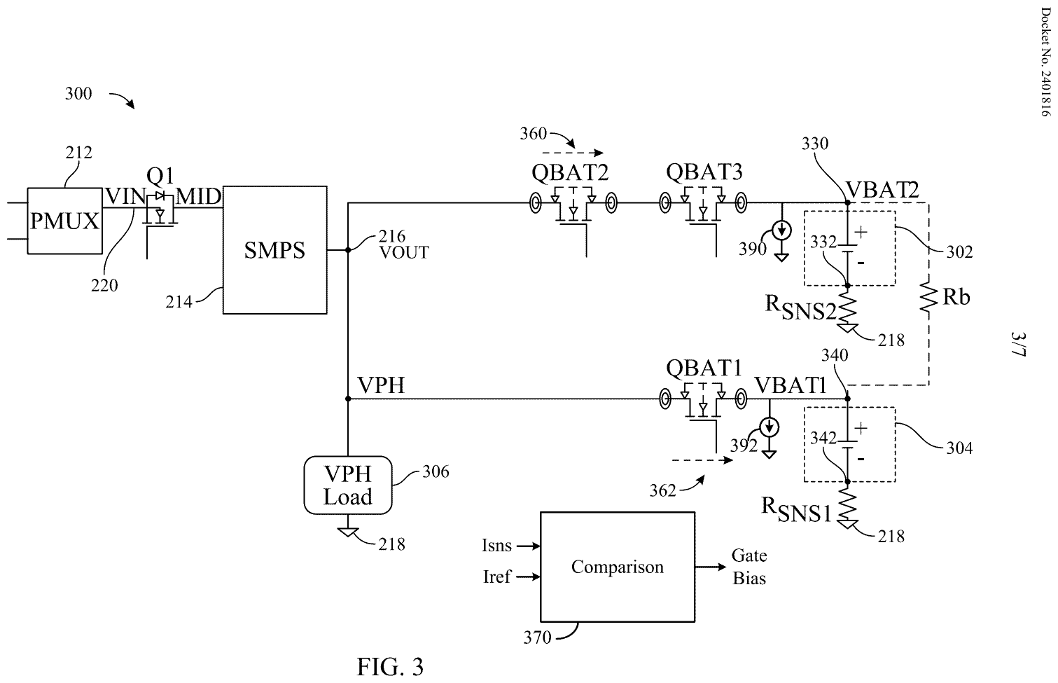

FIG. 3 is a circuit diagram of an example power supply circuit 300 that includes a switching regulator (e.g., the SMPS circuit 214) as a single charger and independently controlled charging paths (e.g., charging paths 360, 362), in accordance with certain aspects of the present disclosure. For certain aspects, the power supply circuit 300 may include the power multiplexer 212, the transistor Q1, and the SMPS circuit 214 (or another suitable SMPS circuit). The power supply circuit 300 may also include a load 306 (e.g., labeled “VPH Load”), a first switch (e.g., implemented by one or more transistors QBAT1), a second switch (e.g., implemented by one or more transistors QBAT2 and/or QBAT3), a first battery 304 (BAT1), a second battery 302 (BAT2), a first sense resistive element R_{SNS1}, a second sense resistive element R_{SNS2}, and a balancing resistive element Rb. For certain aspects, the batteries 302, 304 may be external to an integrated circuit (IC) (e.g., a PMIC), whereas at least a portion of the switching regulator and the switches (implemented by transistors QBAT1 and QBAT2) may be internal to the IC. The sense resistive elements R_{SNS1} and R_{SNS2} may be internal or external to the IC, or one sense resistive element may be internal while the other is external. For certain aspects, either or both of the sense resistive elements R_{SNS1} and R_{SNS2} may be eliminated, and the on-resistance(s) of the corresponding transistors QBAT1 and/or QBAT2 may be used for current sensing.

The load 306 may represent one or more circuits of a device (e.g., the device 100 of FIG. 1) that are powered internally by the switching regulator (e.g., with power supply rail VPH=VOUT). The load 306 may be coupled (e.g., in shunt) to the reference potential node 218.

In certain aspects, the first battery 304 and/or the second battery 302 may represent a single-cell (1S) battery, a two-cell-in-series (2S) battery, or more than two stacked cells in a battery (e.g., a multi-cell-in-series battery). The charging architecture illustrated in FIG. 3 represents a 1S2P configuration. In some cases, the first battery 304 and the second battery 302 may be symmetrical batteries, having the same capacity (and size). In other cases, the first battery 304 and the second battery 302 may be asymmetrical batteries, each with a different capacity (and size). For example, the power supply circuit 300 may be included in a device that is foldable, which may include a first portion coupled to a second portion by a hinge. In this example, the first portion of the foldable device may include the first battery 304, and the second portion of the foldable device may include the second battery 302.

In certain aspects, the output voltage node 216 of the SMPS circuit 214 may be coupled to transistor(s) QBAT1, transistor(s) QBAT2, and the load 306. In certain aspects, one or more of transistors QBAT1 and QBAT2 may be bidirectional switches, each implemented with one or more transistors. In some cases, transistor(s) QBAT1 and/or QBAT2 may be implemented by back-to-back transistors or a body-switchable transistor, for example. The gates of the QBAT1 and QBAT2 transistors may be driven by logic circuitry (e.g., the control logic 201 of FIG. 2 or other logic not shown in FIG. 3).

In certain aspects, transistor(s) QBAT1 may be coupled to the first battery 304 via a first battery voltage node 340 (labeled “VBAT1,” which may also represent a terminal for the first battery), and transistor(s) QBAT2 may be coupled to the second battery 302 via a second battery voltage node 330 (labeled “VBAT2,” which may also represent a terminal for the second battery). The first battery 304 may be coupled to the first sense resistive element R_{SNS1} via another first battery voltage node 342 (e.g., coupled to the negative terminal of the first battery 304), and the second battery 302 may be coupled to the second sense resistive element R_{SNS2} via another second battery voltage node 332 (e.g., coupled to the negative terminal of the second battery 302). The first and second sense resistive elements R_{SNS1} and R_{SNS2} may function as sensing resistors to measure the current through the first battery 304 and the second battery 302, respectively.

When the batteries 302, 304 are external to an IC with other circuitry of the power supply circuit 300, the IC may include a positive first battery port (e.g., a pin) coupled to the first battery voltage node 340 and to the positive terminal of the first battery 304. In some cases, the IC may include a negative first battery port coupled to the other first battery voltage node 342, to the first sense resistive element R_{SNS1}, and to the negative terminal of the first battery 304. Additionally or alternatively, the IC may include a positive second battery port coupled to the second battery voltage node 330 and to the positive terminal of the second battery 302. In some cases, the IC may include a negative second battery port coupled to the other second battery voltage node 332, to the sense resistive element R_{SNS2}, and to the negative terminal of the second battery 302. The sense resistive elements R_{SNS1} and R_{SNS2} may be coupled to the reference potential node 218.

In certain aspects, the positive terminals of the first battery 304 and the second battery 302 may be coupled together via the balancing resistive element Rb. In some cases, the balancing resistive element Rb may be implemented as a 100Ω resistor, for example. The balancing resistive element Rb may be internal to the IC (coupled between the first battery voltage node 340 and the second battery voltage node 330) or may be external to the IC. The balancing resistive element Rb may be used to balance the two batteries during charging or when the device is powered off and the batteries 302, 304 begin discharging.

The power supply circuit 300 may perform charging (via the SMPS circuit 214) of both the first battery 304 and the second battery 302 through two independently controlled charging paths 360, 362. Electrical power received from a wall adapter or wireless charger, for example, at the power multiplexer 212 may be converted by the SMPS circuit 214 and used to independently charge the first battery 304 (e.g., through charging path 362) and the second battery 302 (e.g., charging path 360). For example, current from the output voltage node 216 may be routed to the first battery voltage node 340 via transistor(s) QBAT1 in the charging path 362, for charging the first battery 304. Similarly, current from the output voltage node 216 may be routed to the second battery voltage node 330 via transistor(s) QBAT2 in the charging path 360, for charging the second battery 302. In certain aspects, transistor(s) QBAT1 may be configured to independently control and monitor charging of the first battery 304 (via charging path 362), and transistor(s) QBAT2 may be configured to independently control and monitor charging of the second battery 302 (via charging path 360).

Having one or more transistors (e.g., transistor(s) QBAT1 or QBAT2) in each charging path may allow for independent charging control for the batteries, including trickle, pre-charge, constant current (CC), constant voltage (CV), and/or termination charging. In certain aspects, independently monitoring the charging of the multiple independent batteries may include independently monitoring the level of charge in the batteries via these transistors. Additionally or alternatively, independently monitoring the charging of the multiple independent batteries may include independent current sensing, battery measurement, and/or current limit regulation (total or individual) for the batteries. The presence of one or more transistors in each charging path may eliminate the use of impedance-balancing circuitry (e.g., a current limit switch) between the multiple independent batteries, because the transistor(s) in each charging path may be used to perform current limit regulation. For example, the power supply circuit 300 may lack a current limit switch between the first battery 304 and the second battery 302.

Flexibility may also be provided in the end of charge for the batteries (e.g., battery end of charge may be dependent on current for a single battery, the total current for multiple batteries, or the battery state of charge (SOC)). The independent charging path switches (e.g., transistors QBAT1 and QBAT2) may be internal (integrated in the PMIC), or one or more of the switches may be external to the PMIC. The temperature of the batteries can be independently monitored and, based on the sensed battery temperature(s), appropriate action may be taken (e.g., charging may be suspended, charging voltage and/or current may be reduced, etc.) via the independent charging path switches. For example, when the temperature of the second battery 302 is too high, transistor(s) QBAT2 may be effectively opened, or the charging current may be reduced in increments or suspended.

The power supply circuit 300 may perform charging of a single battery (e.g., the first battery 304) using a single charger. For example, the second battery 302 may have been disconnected and/or removed from the power supply circuit 300. In this singe-cell-in-series, single-cell-in-parallel (1S1P) configuration, transistor(s) QBAT2 may be used as a bypass switch (e.g., a bypass FET). The power supply circuit 300 may enable power-on for a device (e.g., device 100) when only a single battery is connected, and may also prevent over-charging of the single connected battery.

In some cases, it may be desirable to utilize parallel charging to charge multiple independent batteries to speed up charging (e.g., when the batteries have greater power levels). In one example parallel charging solution, a main charger (e.g., the SMPS circuit 214) is capable of charging multiple independent batteries (e.g., the first battery 304 and the second battery 302) and providing power by itself or may be paralleled with one or more auxiliary chargers.

In some aspects, the power supply circuit 300 may include a regulation component 370 (e.g., a comparison component). The regulation component may receive a sensed current (Isns) and a reference current (Iref), which may be used to generate at least one gate bias signal to control QBAT1, QBAT2, and/or QBAT3, as described in more detail herein.

### Example Soft Start Techniques

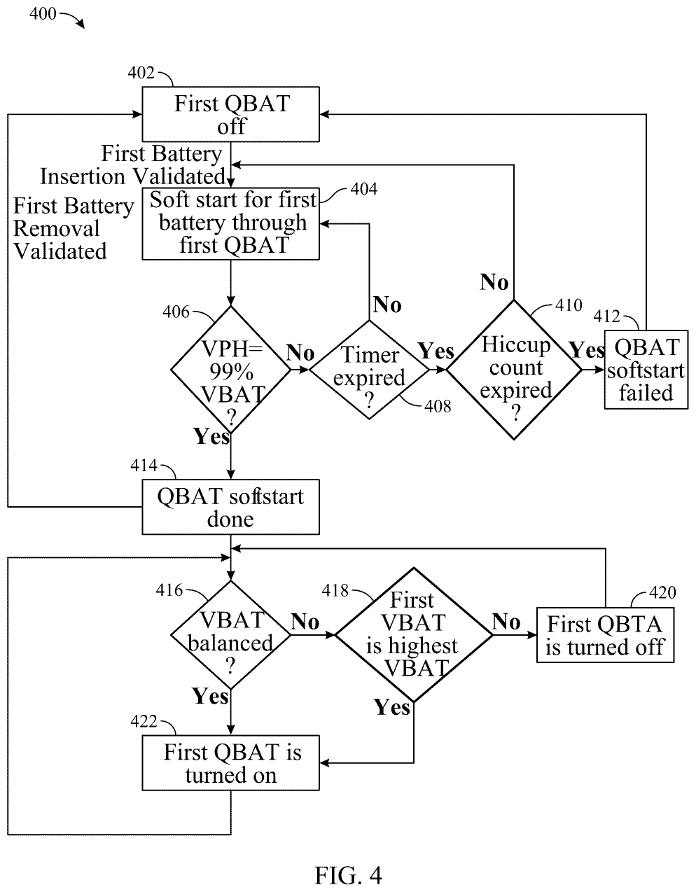

Certain aspects of the present disclosure are directed towards techniques for soft starting one or more batteries in a single-cell-in-series, two-cells-in-parallel (1S2P) configuration as described in more detail herein with respect to FIG. 4. While some example techniques are described with respect to a 1S2P configuration to facilitate understanding, the aspects of the present disclosure may be applied to configurations having any number of parallel batteries. Soft start refers to a phase during which one or more associated transistors (e.g., QBAT1 for battery 304 or QBAT2/QBAT3 for battery 302) are biased in a linear region of operation before the transistors are fully turned on (e.g., biased in saturation). Soft start may be performed to charge an output capacitive element (e.g., capacitive element 210 of FIG. 2) to a voltage that is within a certain threshold of the battery voltage before the associated transistor for the battery is fully turned on, as described in more detail herein.

FIG. 4 illustrates example operations 400 for soft starting a first battery (e.g., battery 302), in accordance with certain aspects of the present disclosure. While operations 400 describe the soft start for the first battery, the operations may be applied for the soft start of any battery (e.g., a second battery, such as battery 304) in an independent fashion. That is, the operations 400 may be performed to soft start the first battery, and independently, the operations 400 may be performed to soft start the second battery. At block 402, a first QBAT (e.g., QBAT1 of FIG. 3) for the first battery may be off. In some aspects, insertion of the first battery may be validated, in response to which soft start for the first battery through the first QBAT may be performed at block 404. For example, the first QBAT may be biased in a linear region of operation to begin charging the output capacitive element using the first battery. The soft start may continue until VPH (e.g., the voltage across the output capacitive element and at the output voltage node 216) is within a threshold voltage difference of VBAT for the first battery (e.g., is above 99% of VBAT), as determined at block 406. If, at block 406, the controller determines that VPH is not within the threshold voltage difference of VBAT for the first battery, the controller may determine whether a timer has expired at block 408 and may continue performing the soft start operations until the timer expires.

In some cases, the controller may maintain a counter (e.g., also referred to as a “hiccup counter”). For example, each time the controller determines that the timer has expired at block 408, the counter may be decremented until the counter reaches 0 (e.g., a hiccup count expires) at block 410. Alternatively, the counter may start from a count of 0 and may be incremented until a predefined count is reached. At that point, the controller may determine, at block 412, that the soft start for the first battery has failed and may turn off the QBAT for the first battery, as shown. If the counter has not counted to 0 or a predefined value, the soft start may start over as if the battery was first plugged in.

Once VPH is within a threshold voltage difference of VBAT of the first battery as determined at block 406, the controller may determine, at block 414, that soft start for the first battery is complete and may fully turn on (e.g., bias in saturation) the first QBAT for the first battery. If the first battery is removed, the first QBAT may be turned off at block 402, as shown.

In some aspects, the second battery may be inserted (e.g., after the first battery soft start has been completed and the first QBAT is fully turned on). The controller may determine, at block 416, whether the VBATs of the first and second batteries are balanced (e.g., the VBATs are within a threshold voltage difference such as 10 mV). If the VBATs are balanced, the first QBAT for the first battery may be turned on (e.g., or remain turned on). Independently, as part of soft start operations for the second battery, the second QBAT for the second battery may be fully turned on (e.g., after the soft start for the second QBAT has been completed), resulting in the transistors for both batteries being fully on.

If the VBATs are not balanced, the controller may determine, at block 418, whether the first VBAT for the first battery is the highest VBAT of batteries plugged into the device (e.g., if the first VBAT is greater than the second VBAT of the second battery). If not, the first QBAT for the first battery may be turned off at block 420. The first QBAT may remain off until the VBATs are balanced (e.g., due to the discharge of the second battery due to the VPH load). Suppose the first VBAT of the first battery is the highest VBAT (e.g., is greater than the second VBAT of the second battery, as determined at block 418). In that case, the first QBAT for the first battery may be turned on at block 422. The transistor for the second battery may be independently controlled. As described, a soft start for the second battery (e.g., bias the second QBAT in the linear region) may be performed independently from the first battery soft start. Similarly, for the second battery, soft start may be performed until VPH is within a threshold voltage difference of the second VBAT of the second battery. Once soft start has been completed for the second battery, whether the second QBAT is fully turned on or turned off depends on whether the second VBAT is the highest VBAT or if there is a VBAT balance.

In some aspects, attachment (e.g., plugging in) of either battery may trigger a soft start. The batteries described herein may be attached (e.g., plugged in) in any suitable sequence or order. Battery attachment and removal may be detected by checking one or more flags indicating that the battery has been attached or by checking whether the associated VBAT of the battery is greater than a certain threshold voltage.

If the second battery is attached and the first battery has not finished soft start, soft start for the second battery may be started (e.g., regardless of what the second VBAT is for the second battery). Once the battery with the lower VBAT finishes soft start, the controller may determine whether the VBATs are balanced (e.g., are within a threshold voltage difference, which may be 10 mV). If the VBATs are balanced, soft start for the first battery may completed. Independently, the soft start for the second battery may be performed and completed. The first and second QBATs for the first and second batteries may be fully turned on based on respective soft start operations being completed. In other words, the completion of the soft start is determined independently for each battery. After one battery soft start is completed, whether or not to turn on the QBAT of the battery is based on voltage balance and the comparison of the associated VBAT of the battery to VBAT(s) of one or more other batteries.

If the VBATs are not balanced, the QBAT for the battery with the lower VBAT may exit soft start operation after VPH reaches the lower VBAT and the associated QBAT is turned off. Soft start may be performed for the battery with the higher voltage, which allows the VPH to be increased to the VBAT of the battery with the higher voltage. Once the soft start for the battery with the higher voltage is complete, the soft start operations may end, and the QBAT for the battery with the higher voltage may be fully turned on.

Suppose a second battery is attached after the first battery has finished soft start. In that case, the second QBAT for the second battery may be fully turned on, soft start may be performed for the second battery, or the second battery may be turned off, based on whether the VBATs of the batteries are balanced, as described herein with respect to FIG. 4.

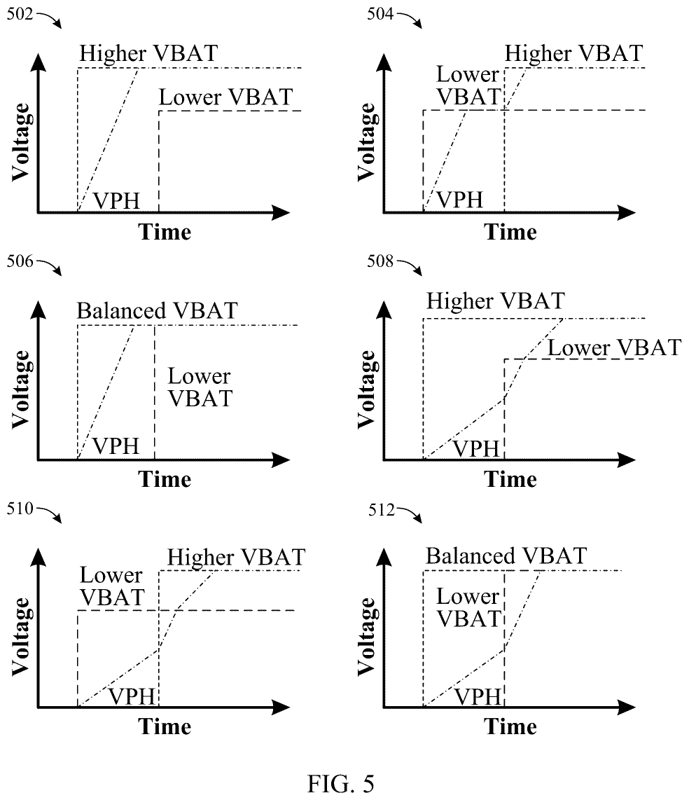

FIG. 5 illustrates graphs showing battery voltages and VPH as batteries are being plugged in, in accordance with certain aspects of the present disclosure. As shown in graph 502, if a battery with the higher VBAT is plugged in first, soft start for the battery may be performed until VPH reaches (e.g., is within a threshold voltage difference of) the higher VBAT. A battery with a lower VBAT may be plugged in after the soft start for the higher VBAT has finished. In this case, the soft start of the lower VBAT battery may finish quickly since VPH is already higher than the lower VBAT, and the associated QBAT for the lower VBAT battery may be turned off after soft start mode in a short period of time (e.g., typically 1-2 digital clock cycles).

As shown in graph 504, a lower VBAT battery may be plugged in first, and soft start may be performed for the lower VBAT battery until VPH reaches (e.g., is within a threshold voltage difference of) the lower VBAT. After soft start for the lower VBAT battery is completed, a higher VBAT battery may be plugged in. The QBAT for the lower VBAT battery may be turned off, and soft start for the higher VBAT battery may be performed until VPH reaches the higher VBAT, as shown.

As shown in graph 506, a first battery may be first plugged in, and soft start may be performed for the first battery. The soft start for the first battery may be complete, and the QBAT for the first battery may be fully turned on. A second battery may be plugged in after the soft start for the first battery has completed, where the VBATs of the batteries are balanced. Since the VBATs are balanced, and VPH has already reached the second VBAT, the QBAT for the second battery may go through soft start quickly (e.g., within 1-2 digital clock cycles) and then may be fully turned on.

As shown in graph 508, a higher VBAT battery may be plugged in, and soft start may be performed for the higher VBAT battery. Before soft start has completed for the higher VBAT battery, a lower VBAT battery may be plugged in, and soft start may be performed for both batteries (e.g., both QBATs for both batteries are biased in the linear region). Once soft start has completed for the lower VBAT battery (e.g., VPH has reached the lower VBAT), the QBAT for the lower VBAT battery may be turned off, and soft start may be continued for the higher VBAT battery until VPH reaches the higher VBAT, as shown.

As shown in graph 510, if the lower VBAT battery is plugged in first, soft start for the lower VBAT battery may be performed. A higher VBAT battery may be plugged in before the soft start for the lower VBAT battery has completed. Soft start may be performed for both batteries (e.g., both QBATs for both batteries are biased in the linear region) until VPH reaches the lower VBAT. Then, the QBAT for the lower VBAT battery may be turned off, and soft start for the higher VBAT battery may be continued until VPH reaches the higher VBAT, as shown.

As shown in graph 512, a first battery may be first plugged in, and soft start may be performed for the first battery. A second battery may be plugged in before the soft start for the first battery has completed, where the VBATs of the batteries are balanced. Soft start may be performed for both batteries until VPH reaches the balanced VBAT, as shown.

As described herein, where the VBATs of batteries are not balanced, soft start may be performed until VPH reaches the higher battery voltage. Certain aspects provide support for operating with a battery-only mode during soft start. If the VBATs of the batteries plugged in are unbalanced, the battery with the higher voltage may support the VPH load (e.g., load 306). If the VBATs are balanced, both batteries will support the VPH load 306.

In some aspects, an input voltage (VIN) may be provided at any time with respect to when a battery is plugged in. For example, the electronic device may be plugged into a voltage supply (e.g., a universal serial bus (USB) device) and receive VIN. In this case, soft start may be performed until VPH reaches a maximum of a system minimum voltage (e.g., a minimum voltage for operating the electronic device), VBAT1_track (e.g., a reference voltage that is higher than but tracks a VBAT of a first battery), and VBAT2_track (e.g., a reference voltage that is higher than but tracks a VBAT of a second battery). While receiving the input voltage, the input voltage supply may provide the VPH load. If the input current is unable to support the VPH load, the higher VBAT battery (or both batteries if the VBATs are balanced) may supplement the VPH load, as described.

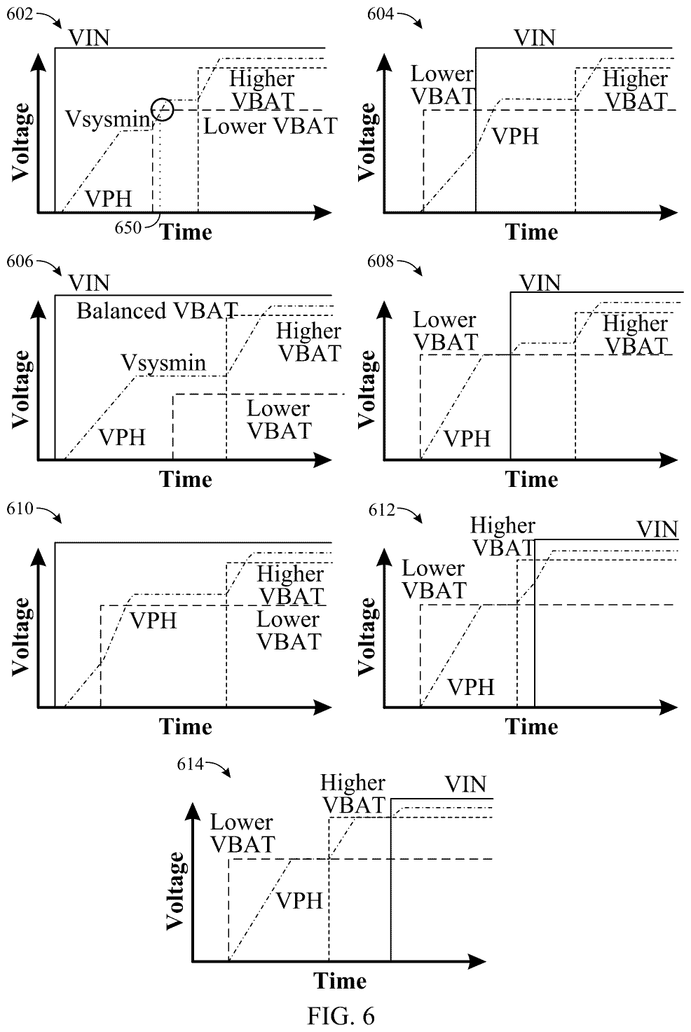

FIG. 6 illustrates graphs showing VIN, battery voltages, and VPH in response to providing VIN and plugging in batteries, in accordance with certain aspects of the present disclosure. As shown in graph 602, the device may be plugged into a voltage supply providing VIN, based on which the output capacitive element (e.g., capacitive element 210 of FIG. 2) may be charged, increasing VPH until VPH reaches Vsysmin (e.g., a threshold voltage sufficient to support device operations). After VPH reaches Vsysmin, a lower VBAT battery may be plugged in, and soft start may be performed for the lower VBAT battery until VPH reaches VBAT_track for the lower VBAT (e.g., reaches a reference voltage that is higher than but tracks the lower VBAT). As shown, while VPH is lower than the lower VBAT, power to charge the output capacitive element may be provided from both the lower VBAT battery and the voltage supply providing VIN. Once VPH reaches the lower VBAT, power to charge the output capacitive element may be provided only from the voltage supply (e.g., causing the reduced rate of VPH increase shown at time 650). Later, a higher VBAT battery may be plugged in, and VPH may be increased until VPH reaches VBAT_track for the higher VBAT in a similar manner.

As shown in graph 604, the lower VBAT battery may be plugged in first, and soft start may begin for the lower VBAT battery. Before the soft start for the lower VBAT battery is finished, the device may be plugged into the voltage supply providing VIN. Thus, VPH may be increased until VPH reaches VBAT_track for the lower VBAT, as shown. Later, the higher VBAT battery may be plugged in, and VPH may be increased until VPH reaches VBAT_track for the higher VBAT.

As shown in graph 606, the device may be plugged into the voltage supply providing VIN, and VPH increases to reach Vsysmin, as described. Later, a lower VBAT battery may be plugged in where the lower VBAT is less than Vsysmin. Thus, VPH may remain at Vsysmin, as shown. Once the higher VBAT battery is plugged in, VPH may be increased to reach VBAT_track for the higher VBAT.

As shown in graph 608, the lower VBAT battery may be plugged in, and soft start may be performed for the lower VBAT battery until VPH reaches the lower VBAT as shown, and the QBAT associated with the lower VBAT battery may be fully turned on. Later, the device may be plugged into the power supply providing VIN, QBAT associated with the lower VBAT battery may be fully turned off, and VPH may be increased to VBAT_track for the lower VBAT (e.g., using power from the power supply). The higher VBAT battery may then be plugged in, and VPH may be increased to VBAT_track for the higher VBAT, as shown.

As shown in graph 610, the device may be plugged into the voltage supply providing VIN, and VPH may be increased. Before VIN reaches Vsysmin, a lower VBAT battery may be plugged in. Thus, VPH may be increased to VBAT_track for the lower VBAT as shown. A higher VBAT battery may be plugged in later, and VPH may be increased to VBAT_track for the higher VBAT.

As shown in graph 612, the lower VBAT battery may be plugged in, and soft start may be performed for the lower VBAT battery until VPH reaches the lower VBAT, as shown. Then, the higher VBAT battery may be plugged in. In response, the QBAT for the lower VBAT battery may be turned off, and soft start may be performed for the higher VBAT. Before the soft start for the higher VBAT battery is complete (e.g., before VPH reaches the higher VBAT), the device may be plugged into the voltage supply, and VPH may be increased to reach VBAT_track for the higher VBAT, as shown.

As shown in graph 614, the lower VBAT battery may be plugged in, and soft start may be performed for the lower VBAT battery until VPH reaches the lower VBAT, as shown. Then, the higher VBAT battery may be plugged in. In response, the QBAT for the lower VBAT battery may be turned off, and soft start may be performed for the higher VBAT battery until VPH reaches the higher VBAT. Later, the device may be plugged into the voltage supply, and VPH may be increased to VBAT_track for the higher VBAT.

In some cases, a device may be placed in ship mode or automatic fault protection (AFP) mode. In ship mode or AFP mode, the SMPS circuit 214 and QBATs of the batteries may be turned off. Upon exiting ship or AFP mode, soft start may be performed as described with respect to FIGS. 5 and 6. For example, soft start may be performed based on an assumption that the electronic device is plugged into an external voltage supply and the batteries are being plugged in at the same time. VPH may be increased to reach VBAT_track for the higher VBAT (or to a balanced VBAT when the VBATs of the batteries are balanced).

Certain aspects of the present disclosure provide thermal management techniques. In some aspects, the charger (e.g., battery charger 125) may sense a current across the QBATs for the batteries during soft start, providing a sensed current (Isns), based on which a bias voltage provided to gates of the QBATs may be controlled. For example, for each battery, the regulation component 370 of FIG. 3 may receive a sensed current (Isns) (e.g., current across the associated QBAT) and compare Isns to a reference current (Iref) during soft start. Based on the comparison, the regulation component 370 may be used to control the gate of the associated QBAT. In some aspects, the charger may sense a temperature associated with each QBAT. Suppose the temperature reaches a certain threshold temperature. In that case, Iref may be decreased (e.g., decreasing the gate bias voltage for the QBAT) to lower the QBAT temperature. An adjustment step or slew rate associated with adjusting Iref may be programmable in some aspects.

Certain aspects are directed to managing VPH settling after input (e.g., external voltage supply) or battery removal is detected. That is, once a battery is removed from the device or the device is disconnected from the voltage supply, VPH may be automatically adjusted to a new voltage level based on the removal. For example, suppose a higher VBAT battery is removed and a lower VBAT battery remains. In that case, VPH may be adjusted (e.g., allowed to be decreased due to discharge of the output capacitive clement) to reach the lower VBAT (or to VBAT_track for the lower VBAT if the device is plugged into a voltage supply providing VIN).

In some aspects, software may be used to override one or more batteries to emulate battery removal. That is, the charging path and the discharging path for the battery may be turned off (e.g., the associated QBAT may be turned off) as if the associated battery is missing, providing testing capability and flexibility for the device.

Some aspects of the present disclosure are directed towards techniques for managing residual voltage associated with batteries. As described, whether a battery is attached may be detected by sensing a voltage at a battery (e.g., sensing VBAT) and comparing the sensed voltage to a threshold voltage. However, in some cases, even if a battery is removed, some residual voltage (e.g., due to various parasitic capacitances) may be sensed, causing inaccurate battery detection. In some aspects, the charger may detect VBAT (e.g., VBAT1 for battery 304 of FIG. 3 or VBAT2 for battery 302 of FIG. 3) and if VBAT is higher than some threshold (e.g., 0.7 V), the charger may enable a pulldown current source (e.g., a 10 mA current source) coupled to an associated battery voltage node (e.g., battery voltage node 330 or battery voltage node 340 of FIG. 3) to remove any residual charge if the battery is not attached. For example, referring back to FIG. 3, pulldown current sources 390, 392 may be coupled to nodes 330, 340, respectively, and a respective one of the current sources 390, 392 may be enabled for detection of a respective one of the batteries 302, 304. A current may be sunk via the associated current source from the battery voltage node for a certain period (e.g., 1 ms). After the period, the pulldown current source may be disabled, and VBAT may be sensed and compared to a threshold voltage to determine whether the battery is attached to the device.

Certain aspects of the present disclosure may be implemented using a supercapacitor (e.g., a capacitive element having a capacitance of 5 mF or greater). For example, the output capacitive element 210 may be implemented using a supercapacitor. Due to the comparison of VPH with VBAT during soft start in accordance with the aspects described herein, any suitable capacitive element may be used for the output capacitive element, including a supercapacitor.

Certain aspects of the present disclosure provide a battery-only battery supplement mode. For example, a lower VBAT battery may be plugged in, and soft start for the lower VBAT battery may be completed. With a valid first battery, the system can be powered up and allow VPH loading. Then, a higher VBAT battery may be plugged in. As described herein, the QBAT for the lower VBAT battery may be turned off to perform a soft start for the higher VBAT battery, and the higher VBAT battery may supply the VPH load. In some scenarios, the current draw from the VPH load may be too high for the higher VBAT battery. For example, if the VPH load draws current during the soft start of the higher VBAT battery, and the current draw of the VPH load is higher than the current that the higher VBAT battery can supply during the soft start, VPH may start to decrease. With battery supplement mode, once VPH drops below the lower VBAT, the QBAT for the lower VBAT battery may be turned on to supplement the VPH load with the higher VBAT battery. As another example, if the lower VBAT is close to the higher VBAT (e.g., within a threshold voltage difference) but is not considered balanced, only the QBAT for the higher VBAT battery may be turned on. If current draw from the VPH load occurs, VPH may drop below the lower VBAT due to the equivalent series resistance (ESR) of the higher VBAT battery. As a result, the lower VBAT battery may be used to supplement the VPH load with the higher VBAT battery.

Certain aspects of the present disclosure are directed towards over-current protection. After the soft start has been completed for balanced batteries, both QBATs are allowed to be turned on to provide VPH load support. In some aspects, a local current limit function may be implemented in an attempt to prevent current from one battery flowing to one or more other batteries in case one or more battery voltages fluctuate unexpectedly. For example, VBAT of battery 302 may fluctuate, causing current to flow from battery 302 to battery 304. In some aspects, the regulation component 370 may monitor the current (e.g., receive Isns) across the QBAT for each battery, and if the current exceeds some current threshold (e.g., a charging current limit), the regulation component 370 may decrease the bias voltage for the associated QBAT to increase the on-resistance of the QBAT and reduce the current to the battery for protection. The battery open circuit voltage (OCV) may be any value for the two (or more) batteries.

### Example Soft Start Operations

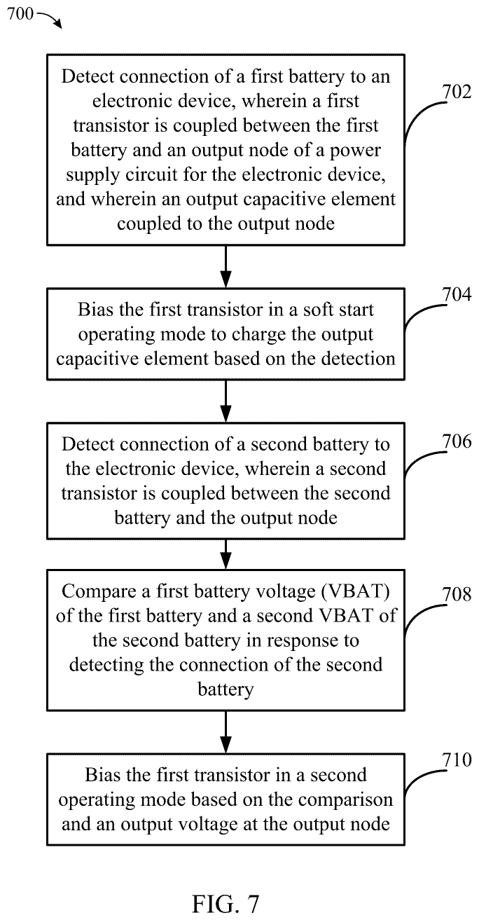

FIG. 7 is a flow diagram of example operations 700 for battery soft start, in accordance with certain aspects of the present disclosure. The operations 700 may be performed by a controller, such as the controller 127 of FIG. 1 and in some cases, a battery charger, such as the battery charger 125 of FIG. 1.

The operations 700 may begin, at block 702, with the controller detecting connection of a first battery (e.g., battery 304) to an electronic device. A first transistor (e.g., QBAT1) is coupled between the first battery and an output node (e.g., output voltage node 216) of a power supply circuit (e.g., power supply circuit 300 of FIG. 3) for the electronic device. An output capacitive element (e.g., capacitive element 210 of FIG. 2) may be coupled to the output node.

At block 704, the controller biases the first transistor in a soft start operating mode to charge the output capacitive element based on the detection. In some aspects, biasing the first transistor in the soft start operating mode may include biasing the first transistor in a linear region of operation.

At block 706, the controller detects connection of a second battery (e.g., battery 302 of FIG. 3) to the electronic device. A second transistor (e.g., QBAT2 or QBAT3 of FIG. 3) may be coupled between the second battery and the output node.

At block 708, the controller compares a first VBAT of the first battery and a second VBAT of the second battery in response to detecting the connection of the second battery and at block 710, biases the first transistor in a second operating mode based on the comparison and an output voltage at the output node (e.g., after the first transistor soft start being completed).

In some aspects, the controller determines that the first VBAT of the first battery is within a threshold voltage difference of the output voltage. The first transistor may be biased in the second operating mode based on the determination.

In some aspects, biasing the first transistor in the second operating mode may include biasing the first transistor in a saturation region of operation based on the first VBAT being higher than the second VBAT.

In some aspects, the controller may bias the second transistor in the soft start operating mode to charge the output capacitive element based on the detection of the connection of the second battery to the electronic device. Biasing the first transistor in the second operating mode may include turning off the first transistor based on the second VBAT being higher than the first VBAT.

In some aspects, biasing the first transistor in the second operating mode may include biasing the first transistor in a saturation region of operation based on the first VBAT and the second VBAT being balanced. The first VBAT and the second VBAT being balanced may involve the first VBAT being with a threshold voltage of the second VBAT. The controller may bias the second transistor in the saturation region based on the first VBAT and the second VBAT being balanced.

In some aspects, the controller may detect connection of the electronic device to an external voltage supply providing VIN before detecting connection of the first battery and the connection of the second battery. In this case, the controller may charge the output capacitive element until the output voltage reaches a minimum operating voltage (e.g., Vsysmin) of the electronic device.

In some aspects, the controller may detect connection of the electronic device to an external voltage supply providing VIN, after detecting connection of the first battery and/or the second battery. The controller may charge the output capacitive element from VIN, and the batteries in parallel, until the output voltage reaches a VBAT tracking voltage (e.g., VBAT_track1 or VBAT_track2 described herein) that is higher than and tracks the first VBAT or the second VBAT (e.g., and is higher than Vsysmin). For example, the controller may charge the output capacitive element until the output voltage reaches the maximum of Vsysmin, VBAT1_track and VBAT2_track.

In some aspects, the controller may detect a temperature associated with the first transistor (e.g., and/or any other QBAT such as the second transistor) during the soft start operating mode. Biasing the first transistor may include reducing a bias voltage provided to a gate of the first transistor based on the temperature exceeding a threshold (e.g., if the temperature exceeds a threshold, the gates of the transistors associated with the connected batteries may be adjusted to reduce the soft start current).

In some aspects, detecting the connection of the first battery (e.g., and any other battery such as the second battery) to the electronic device may include sinking a current (e.g., via current source 392) from a battery voltage node (e.g., battery voltage node 340) for the first battery for a time period. The controller may compare the first VBAT with a threshold voltage after the time period.

In some aspects, the controller may sense a current supplied to the first transistor or the second transistor when the first transistor or the second transistor is operated in the second operating mode. The controller may compare the current to a current threshold and bias a gate of the first transistor or the second transistor based on the comparison of the current to the current threshold (e.g., to limit the charging current and prevent over current for the first battery).

### Example Aspects

In addition to the various aspects described above, specific combinations of aspects are within the scope of the disclosure, some of which are detailed below:

Aspect 1: A method for battery soft start, comprising: detecting connection of a first battery to an electronic device, wherein a first transistor is coupled between the first battery and an output node of a power supply circuit for the electronic device, and wherein an output capacitive element is coupled to the output node; biasing the first transistor in a soft start operating mode to charge the output capacitive element based on the detection; detecting connection of a second battery to the electronic device, wherein a second transistor is coupled between the second battery and the output node; comparing a first battery voltage (VBAT) of the first battery and a second VBAT of the second battery in response to detecting the connection of the second battery; and biasing the first transistor in a second operating mode based on the comparison and an output voltage at the output node.

Aspect 2: The method of Aspect 1, wherein biasing the first transistor in the soft start operating mode comprises biasing the first transistor in a linear region of operation.

Aspect 3: The method of Aspect 1 or 2, further comprising determining that the first VBAT of the first battery is within a threshold voltage difference of the output voltage, wherein the first transistor is biased in the second operating mode based on the determination.

Aspect 4: The method according to any of Aspects 1-3, wherein biasing the first transistor in the second operating mode comprises biasing the first transistor in a saturation region of operation based on the first VBAT being higher than the second VBAT.

Aspect 5: The method of Aspect 4, further comprising turning off the second transistor based on the first VBAT being higher than the second VBAT.

Aspect 6: The method according to any of Aspects 1-5, further comprising biasing the second transistor in the soft start operating mode to charge the output capacitive element based on the detection of the connection of the second battery to the electronic device, wherein biasing the first transistor in the second operating mode comprises turning off the first transistor based on the second VBAT being higher than the first VBAT.

Aspect 7: The method according to any of Aspects 1-6, wherein biasing the first transistor in the second operating mode comprises biasing the first transistor in a saturation region of operation based on the first VBAT and the second VBAT being balanced.

Aspect 8: The method of Aspect 7, wherein the first VBAT and the second VBAT being balanced comprises the first VBAT being within a threshold voltage difference of the second VBAT.

Aspect 9: The method of Aspect 7 or 8, further comprising biasing the second transistor in the saturation region based on the first VBAT and the second VBAT being balanced.

Aspect 10: The method according to any of Aspects 1-9, further comprising: detecting connection of the electronic device to an external voltage supply providing an input voltage (VIN) before detecting the connection of the first battery and the connection of the second battery; and charging the output capacitive element until the output voltage reaches a minimum operating voltage of the electronic device based on detecting the connection of the electronic device to the external voltage supply.

Aspect 11: The method according to any of Aspects 1-10, further comprising: detecting connection of the electronic device to an external voltage supply providing an input voltage (VIN); and charging the output capacitive element until the output voltage reaches a VBAT tracking voltage that is higher than and tracks the first VBAT or the second VBAT based on detecting the connection of the electronic device to the external voltage supply.

Aspect 12: The method according to any of Aspects 1-11, further comprising detecting a temperature associated with the first transistor during the soft start operating mode, wherein biasing the first transistor comprises reducing a bias voltage provided to a gate of the first transistor based on the temperature exceeding a threshold.

Aspect 13: The method according to any of Aspects 1-12, wherein detecting the connection of the first battery to the electronic device comprises: sinking a current from a battery voltage node for the first battery for a time period; and comparing the first VBAT with a threshold voltage after the time period.

Aspect 14: The method according to any of Aspects 1-13, further comprising: sensing a current supplied to the first transistor or the second transistor when the first transistor or the second transistor is operated in the second operating mode; comparing the current to a current threshold; and biasing a gate of the first transistor or the second transistor based on the comparison of the current to the current threshold.

Aspect 15: An electronic device, comprising: a power supply circuit including a first transistor coupled between a terminal for a first battery and an output node of the power supply circuit, a second transistor coupled between a terminal for a second battery and the output node, and an output capacitive element coupled to the output node; and a controller coupled to the power supply circuit and configured to: detect connection of the first battery to the electronic device; bias the first transistor in a soft start operating mode to charge the output capacitive element based on the detection; detect connection of the second battery to the electronic device; compare a first battery voltage (VBAT) of the first battery and a second VBAT of the second battery in response to detecting the connection of the second battery; and bias the first transistor in a second operating mode based on the comparison and an output voltage at the output node.

Aspect 16: The electronic device of Aspect 15, wherein, to bias the first transistor in the soft start operating mode, the controller is configured to bias the first transistor in a linear region of operation.

Aspect 17: The electronic device of Aspect 15 or 16, wherein the controller is further configured to determine that the first VBAT of the first battery is within a threshold voltage difference of the output voltage and wherein the controller is configured to bias the first transistor in the second operating mode based on the determination.

Aspect 18: The electronic device according to any of Aspects 15-17, wherein, to bias the first transistor in the second operating mode, the controller is configured to bias the first transistor in a saturation region of operation based on the first VBAT being higher than the second VBAT.

Aspect 19: The electronic device of Aspect 18, wherein the controller is configured to turn off the second transistor based on the first VBAT being higher than the second VBAT.

Aspect 20: The electronic device according to any of Aspects 15-19, wherein the controller is further configured to bias the second transistor in the soft start operating mode to charge the output capacitive element based on the detection of the connection of the second battery to the electronic device, wherein, to bias the first transistor in the second operating mode, the controller is configured to turn off the first transistor based on the second VBAT being higher than the first VBAT.

Aspect 21: An electronic device, comprising: a power supply circuit including a first transistor coupled between a terminal for a first battery and an output node of the power supply circuit, a second transistor coupled between a terminal for a second battery and the output node, and an output capacitive element coupled to the output node; and a controller coupled to the power supply circuit and configured to: detect connection of the first battery to the electronic device; bias the first transistor in a soft start operating mode to charge the output capacitive element based on the detection; fully turn on the first transistor based on an output voltage at the output node being within a threshold voltage difference of a first battery voltage (VBAT) of the first battery; detect connection of the second battery to the electronic device; determine whether the first VBAT and a second VBAT of the second battery are balanced in response to detecting the connection of the second battery; and bias the second transistor based on the determination.

Aspect 22: The electronic device according to any of Aspects 15-21, wherein, to bias the second transistor, the controller is configured to fully turn on the second transistor based on the first VBAT and the second VBAT being balanced.

Aspect 23: The electronic device according to any of Aspects 15-22, wherein, to bias the second transistor, the controller is configured to bias the second transistor in the soft start mode based on the second VBAT being greater than the first VBAT.

Aspect 24: The electronic device according to any of Aspects 15-23, wherein, to bias the second transistor, the controller is configured to turn off the second transistor based on the second VBAT being less than the first VBAT.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for battery soft start, comprising:
detecting connection of a first battery to an electronic device, wherein a first transistor is coupled between the first battery and an output node of a power supply circuit for the electronic device and wherein an output capacitive element is coupled to the output node;
biasing the first transistor in a soft start operating mode to charge the output capacitive element based on the detection;
detecting connection of a second battery to the electronic device, wherein a second transistor is coupled between the second battery and the output node;
comparing a first battery voltage (VBAT) of the first battery and a second VBAT of the second battery in response to detecting the connection of the second battery; and
biasing the first transistor in a second operating mode based on the comparison and an output voltage at the output node.

2. The method of claim 1, wherein biasing the first transistor in the soft start operating mode comprises biasing the first transistor in a linear region of operation.

3. The method of claim 1, further comprising determining that the first VBAT of the first battery is within a threshold voltage difference of the output voltage, wherein the first transistor is biased in the second operating mode based on the determination.

4. The method of claim 1, wherein:
biasing the first transistor in the second operating mode comprises biasing the first transistor in a saturation region of operation based on the first VBAT being higher than the second VBAT; and
the method further comprises turning off the second transistor based on the first VBAT being higher than the second VBAT.

5. The method of claim 1, further comprising biasing the second transistor in the soft start operating mode to charge the output capacitive element based on the detection of the connection of the second battery to the electronic device, wherein biasing the first transistor in the second operating mode comprises turning off the first transistor based on the second VBAT being higher than the first VBAT.

6. The method of claim 1, wherein:
biasing the first transistor in the second operating mode comprises biasing the first transistor in a saturation region of operation based on the first VBAT and the second VBAT being balanced; and
the first VBAT and the second VBAT being balanced comprises the first VBAT being within a threshold voltage difference of the second VBAT.

7. The method of claim 1, wherein:
biasing the first transistor in the second operating mode comprises biasing the first transistor in a saturation region of operation based on the first VBAT and the second VBAT being balanced; and
the method further comprises biasing the second transistor in the saturation region based on the first VBAT and the second VBAT being balanced.

8. The method of claim 1, further comprising:
detecting connection of the electronic device to an external voltage supply providing an input voltage (VIN) before detecting the connection of the first battery and the connection of the second battery; and
charging the output capacitive element until the output voltage reaches a minimum operating voltage of the electronic device based on detecting the connection of the electronic device to the external voltage supply.

9. The method of claim 1, further comprising:
detecting connection of the electronic device to an external voltage supply providing an input voltage (VIN); and
charging the output capacitive element until the output voltage reaches a VBAT tracking voltage that is higher than and tracks the first VBAT or the second VBAT based on detecting the connection of the electronic device to the external voltage supply.

10. The method of claim 1, further comprising detecting a temperature associated with the first transistor during the soft start operating mode, wherein biasing the first transistor comprises reducing a bias voltage provided to a gate of the first transistor based on the temperature exceeding a threshold.

11. The method of claim 1, wherein detecting the connection of the first battery to the electronic device comprises:
sinking a current from a battery voltage node for the first battery for a time period; and
comparing the first VBAT with a threshold voltage after the time period.

12. The method of claim 1, further comprising:
sensing a current supplied to the first transistor or the second transistor when the first transistor or the second transistor is operated in the second operating mode;
comparing the current to a current threshold; and
biasing a gate of the first transistor or the second transistor based on the comparison of the current to the current threshold.

13. An electronic device, comprising:
a power supply circuit including a first transistor coupled between a terminal for a first battery and an output node of the power supply circuit, a second transistor coupled between a terminal for a second battery and the output node, and an output capacitive element coupled to the output node; and
a controller coupled to the power supply circuit and configured to:
detect connection of the first battery to the electronic device;
bias the first transistor in a soft start operating mode to charge the output capacitive element based on the detection;
detect connection of the second battery to the electronic device;
compare a first battery voltage (VBAT) of the first battery and a second VBAT of the second battery in response to detecting the connection of the second battery; and
bias the first transistor in a second operating mode based on the comparison and an output voltage at the output node.

14. The electronic device of claim 13, wherein, to bias the first transistor in the soft start operating mode, the controller is configured to bias the first transistor in a linear region of operation.

15. The electronic device of claim 13, wherein the controller is further configured to determine that the first VBAT of the first battery is within a threshold voltage difference of the output voltage and wherein the controller is configured to bias the first transistor in the second operating mode based on the determination.

16. The electronic device of claim 13, wherein:
to bias the first transistor in the second operating mode, the controller is configured to bias the first transistor in a saturation region of operation based on the first VBAT being higher than the second VBAT; and
the controller is configured to turn off the second transistor based on the first VBAT being higher than the second VBAT.

17. The electronic device of claim 13, wherein the controller is further configured to bias the second transistor in the soft start operating mode to charge the output capacitive element based on the detection of the connection of the second battery to the electronic device and wherein, to bias the first transistor in the second operating mode, the controller is configured to turn off the first transistor based on the second VBAT being higher than the first VBAT.

18. An electronic device, comprising:
a power supply circuit including a first transistor coupled between a terminal for a first battery and an output node of the power supply circuit, a second transistor coupled between a terminal for a second battery and the output node, and an output capacitive element coupled to the output node; and
a controller coupled to the power supply circuit and configured to:
detect connection of the first battery to the electronic device;
bias the first transistor in a soft start operating mode to charge the output capacitive element based on the detection;
fully turn on the first transistor based on an output voltage at the output node being within a threshold voltage difference of a first battery voltage (VBAT) of the first battery;
detect connection of the second battery to the electronic device;
determine whether the first VBAT and a second VBAT of the second battery are balanced in response to detecting the connection of the second battery; and
bias the second transistor based on the determination.

19. The electronic device of claim 13, wherein, to bias the second transistor, the controller is configured to fully turn on the second transistor based on the first VBAT and the second VBAT being balanced.

20. The electronic device of claim 13, wherein, to bias the second transistor, the controller is configured to bias the second transistor in the soft start operating mode based on the second VBAT being greater than the first VBAT.
